(19) United States
(12) Patent Application Publication
(10) Pub. No.: US 2020/0202535 A1
(43) Pub. Date: Jun. 25, 2020

(54) DRIVER ASSISTANCE APPARATUS AND VEHICLE

(71) Applicant: LG Electronics Inc., Seoul (KR)

(72) Inventors: Kwon LEE, Seoul (KR); Kyuyeol CHAE, Seoul (KR)

(21) Appl. No.: 16/500,601

(22) PCT Filed: Sep. 11, 2018
(86) PCT No.: PCT/KR2018/010593

§ 371 Date: Oct. 3, 2019

(30) Foreign Application Priority Data
Sep. 15, 2017 (KR) 10-2017-0118904

(51) Int. Cl. G06T 7/20; H04N 5/232; H04N 7/18; B60R 1/00; B62D 15/02

(52) U.S. Cl. CPC G06T 7/20; H04N 5/232; H04N 7/18; B60R 1/00; B60R 2300/307; G06T 2207/30252; B60R 2300/10; B60R 2300/20; B62D 15/0265

(57) ABSTRACT

Disclosed is an driver assistance apparatus including a camera configured to capture an image around a vehicle and a processor configured to adjust the frame rate of the camera in order to cause motion blur in an image acquired through the camera, to detect an object based on the image in which the motion blur occurs, and to provide a control signal based on determination as to whether the detected object is located in a blind zone.

### TECHNICAL FIELD

The present disclosure relates to an driver assistance apparatus and a vehicle.

### BACKGROUND ART

A vehicle is an apparatus that moves a passenger in a direction in which the passenger wishes to go. A representative example of the vehicle is a car.

Meanwhile, a vehicle has been equipped with various sensors and electronic devices for convenience of users who use the vehicle. In particular, research on an advanced driver assistance system (ADAS) has been actively conducted for convenience in driving of the user. Furthermore, an autonomous vehicle has been actively developed.

A blind spot detection (BDS) system, which is an example of the advanced driver assistance system, is a system that detects an object located in an area that the sight of a driver does not reach and informs the driver of the same.

The BDS system may be realized using a camera.

In the case in which a structural body is detected based on an image acquired by the camera, complicated calculation is required, whereby cost for realization is increased and real-time realization is difficult. In addition, the possibility of detection errors is increased, which causes inconvenience in use.

### DISCLOSURE

### Technical Problem

The present disclosure has been made in view of the above problems, and it is an object of the present disclosure to provide an driver assistance apparatus capable of detecting an object in a blind zone based on an image acquired by a camera without complicated calculation.

The objects of the present disclosure are not limited to the above-mentioned object, and other objects that have not been mentioned above will become evident to those skilled in the art from the following description.

### Technical Solution

In accordance with the present disclosure, the above objects can be accomplished by the provision of an driver assistance apparatus including a camera configured to capture an image around a vehicle and a processor configured to adjust the frame rate of the camera in order to cause motion blur in an image acquired through the camera, to detect an object based on the image in which the motion blur occurs, and to provide a control signal based on determination as to whether the detected object is located in a blind zone.

The details of other embodiments are included in the following description and the accompanying drawings.

### Advantageous Effects

According to embodiments of the present disclosure, one or more of the following effects are provided.

First, it is possible to detect an object using motion blur, whereby it is possible to detect the object without complicated calculation.

Second, it is possible to provide an object image detected using motion blur to a user.

Third, it is possible to improve the convenience of a driver.

It should be noted that effects of the present disclosure are not limited to the effects of the present disclosure as mentioned above, and other unmentioned effects of the present disclosure will be clearly understood by those skilled in the art from the following claims.

### DESCRIPTION OF DRAWINGS

FIG. 1 is a view showing the external appearance of a vehicle according to an embodiment of the present disclosure.

FIG. 2 is a view showing the exterior of the vehicle according to the embodiment of the present disclosure when viewed at various angles.

FIGS. 3 and 4 are views showing the interior of the vehicle according to the embodiment of the present disclosure.

FIGS. 5 and 6 are reference views illustrating an object according to an embodiment of the present disclosure.

FIG. 7 is a reference block diagram illustrating the vehicle according to the embodiment of the present disclosure.

FIG. 8 is a block diagram of an driver assistance apparatus according to an embodiment of the present disclosure.

FIG. 9 is a flowchart of the driver assistance apparatus according to the embodiment of the present disclosure.

FIG. 10 is an information flowchart of the driver assistance apparatus according to the embodiment of the present disclosure.

FIGS. 11a and 11b are views exemplarily showing an image acquired through a camera according to an embodiment of the present disclosure.

FIG. 12 is a reference view illustrating an operation of displaying an object image detected according to an embodiment of the present disclosure.

FIGS. 13a to 16 are views showing examples in which images are displayed according to an embodiment of the present disclosure.

### BEST MODE

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve different meanings. Also, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present disclosure.

It will be understood that, although the terms “first,” “second,” etc., may be used herein to describe various components, these components should not be limited by these terms. These terms are only used to distinguish one component from another component.

It will be understood that, when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

A vehicle as described in this specification may be a concept including a car and a motorcycle. Hereinafter, a car will be described as an example of the vehicle.

A vehicle as described in this specification may include all of an internal combustion engine vehicle including an engine as a power source, a hybrid vehicle including both an engine and an electric motor as a power source, and an electric vehicle including an electric motor as a power source.

In the following description, “the left side of the vehicle” refers to the left side in the traveling direction of the vehicle, and “the right side of the vehicle” refers to the right side in the traveling direction of the vehicle.

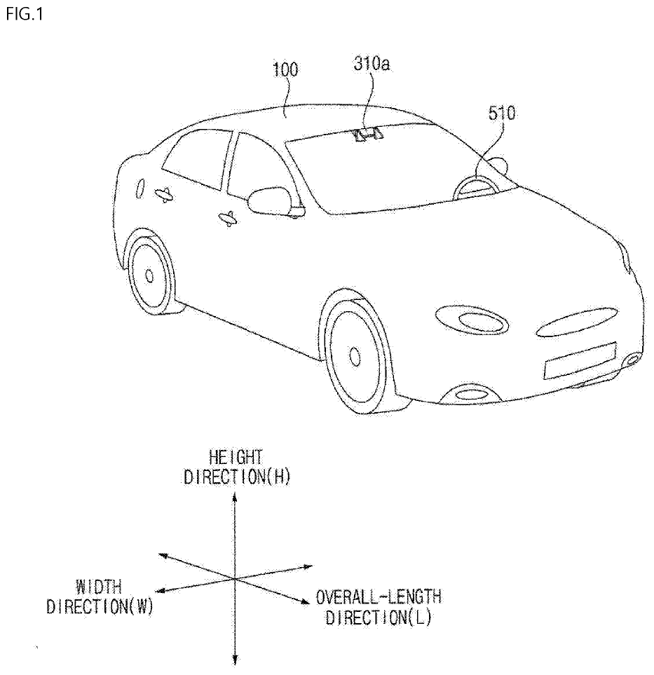

FIG. 1 is a view showing the external appearance of a vehicle according to an embodiment of the present disclosure.

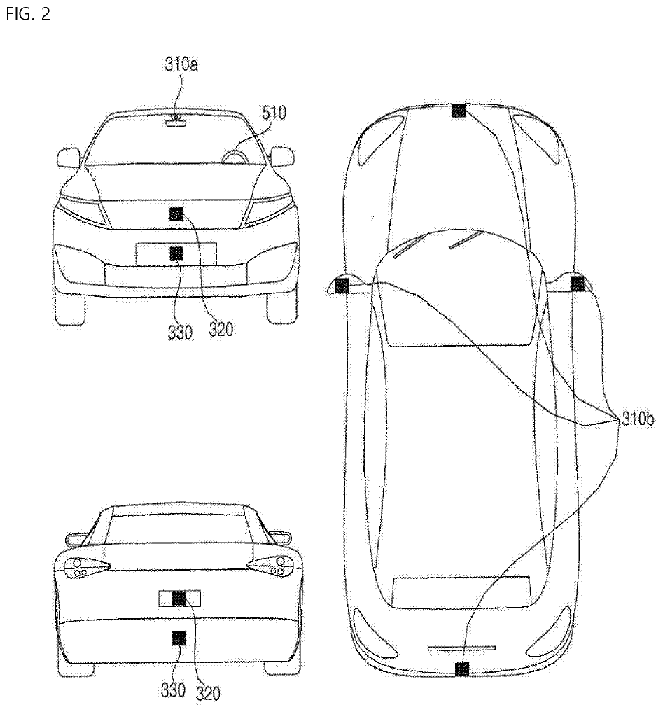

FIG. 2 is a view showing the exterior of the vehicle according to the embodiment of the present disclosure when viewed at various angles.

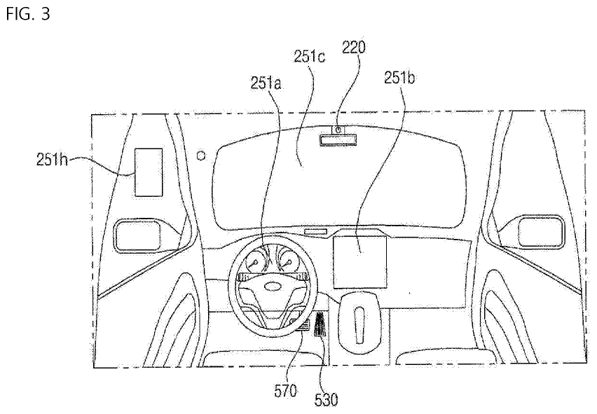

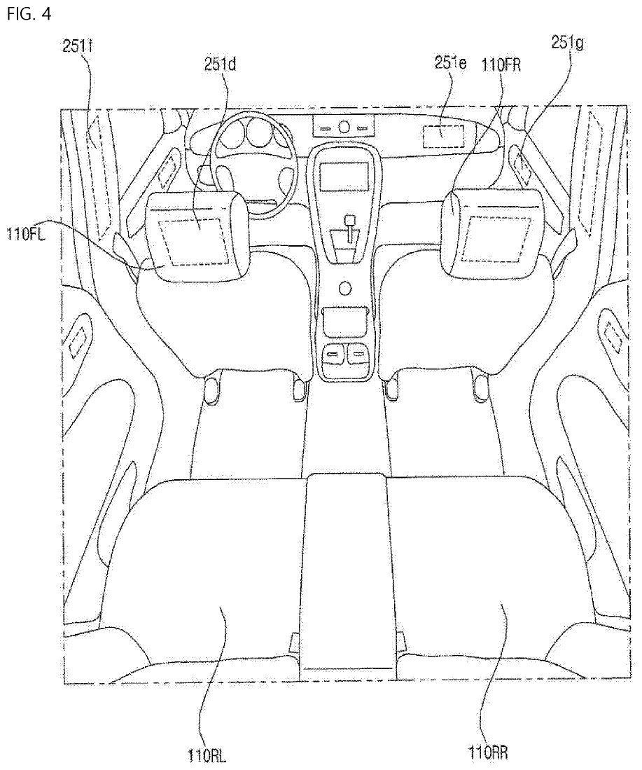

FIGS. 3 and 4 are views showing the interior of the vehicle according to the embodiment of the present disclosure.

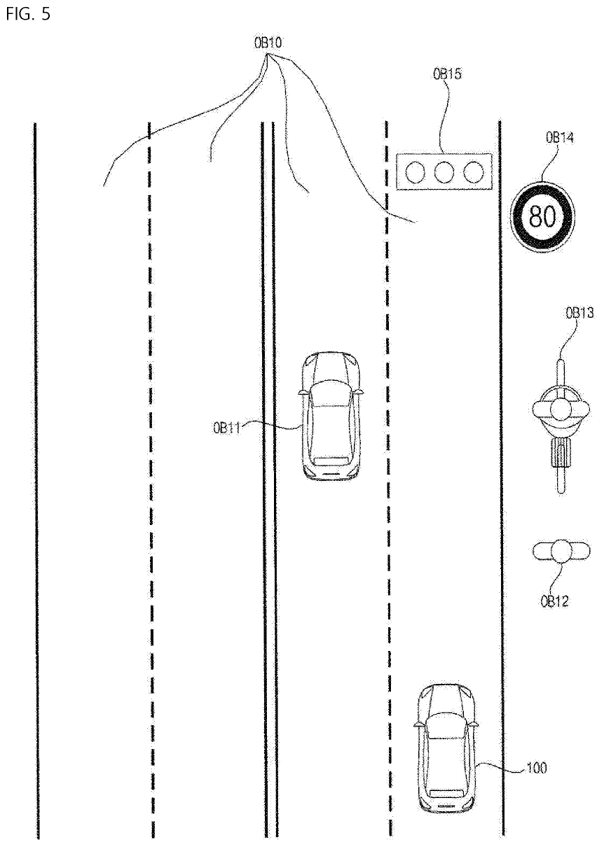

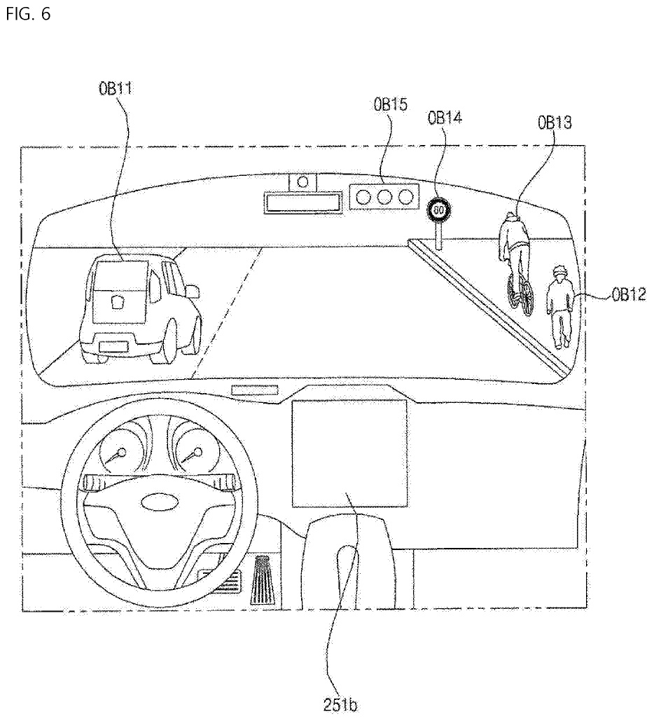

FIGS. 5 and 6 are reference views illustrating an object according to an embodiment of the present disclosure.

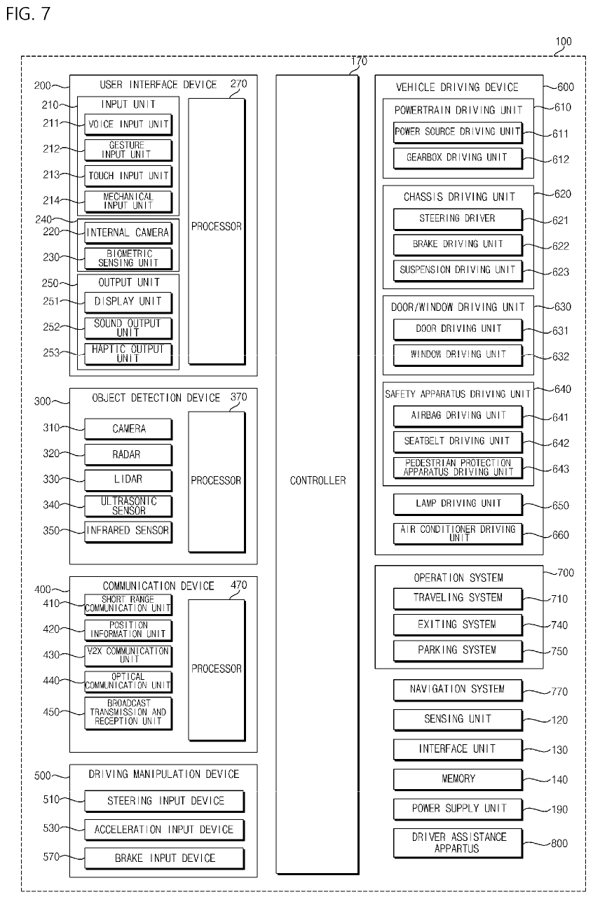

FIG. 7 is a reference block diagram illustrating the vehicle according to the embodiment of the present disclosure.

Referring to FIGS. 1 to 7, the vehicle 100 may include wheels configured to be rotated by a power source and a steering input device 510 configured to adjust the advancing direction of the vehicle 100.

The vehicle 100 may be an autonomous vehicle.

The vehicle 100 may switch between an autonomous mode and a manual mode based on user input.

For example, the vehicle 100 may switch from the manual mode to the autonomous mode or from the autonomous mode to the manual mode based on user input received through a user interface device 200.

The vehicle 100 may switch to the autonomous mode or to the manual mode based on traveling status information.

The traveling status information may include at least one of object information outside the vehicle, navigation information, or vehicle state information.

For example, the vehicle 100 may switch from the manual mode to the autonomous mode or from the autonomous mode to the manual mode based on traveling status information generated by an object detection device 300.

For example, the vehicle 100 may switch from the manual mode to the autonomous mode or from the autonomous mode to the manual mode based on traveling status information received through a communication device 400.

The vehicle 100 may switch from the manual mode to the autonomous mode or from the autonomous mode to the manual mode based on information, data, or a signal provided by an external device.

In the case in which the vehicle 100 is operated in the autonomous mode, the autonomous vehicle 100 may be operated based on an operation system 700.

For example, the autonomous vehicle 100 may be operated based on information, data, or a signal provided by a traveling system 710, an exiting system 740, or a parking system 750.

In the case in which the vehicle 100 is operated in the manual mode, the autonomous vehicle 100 may receive user input for driving through a driving manipulation device 500. The vehicle 100 may be operated based on user input received through the driving manipulation device 500.

“Overall length” means the length from the front end to the rear end of the vehicle, “width” means the width of the vehicle 100, and “height” means the length from the lower end of each wheel to a roof of the vehicle 100. In the following description, “overall-length direction L” may mean a direction based on which the overall length of the vehicle 100 is measured, “width direction W” may mean a direction based on which the width of the vehicle 100 is measured, and “height direction H” may mean a direction based on which the height of the vehicle 100 is measured.

As exemplarily shown in FIG. 7, the vehicle 100 may include a user interface device 200, an object detection device 300, a communication device 400, a driving manipulation device 500, a vehicle driving device 600, an operation system 700, a navigation system 770, a sensing unit 120, an interface 130, a memory 140, a controller 170, and a power supply unit 190.

In some embodiments, the vehicle 100 may further include components other than the components that are described in this specification, or may not include some of the components that are described herein.

The user interface device 200 is a device for communication between the vehicle 100 and a user. The user interface device 200 may receive user input and may provide information generated by the vehicle 100 to the user. The vehicle 100 may realize a user interface (UI) or a user experience (UX) through the user interface device 200.

The user interface device 200 may include an input unit 210, an internal camera 220, a biometric sensing unit 230, an output unit 250, and a processor 270.

In some embodiments, the user interface device 200 may further include components other than the components that are described herein, or may not include some of the components that are described herein.

The input unit 210 is configured to receive information from the user. Data collected by the input unit 210 may be analyzed by the processor 270 and may be processed as a control command of the user.

The input unit 210 may be disposed in the vehicle. For example, the input unit 210 may be disposed in a portion of a steering wheel, a portion of an instrument panel, a portion of a seat, a portion of each pillar, a portion of a door, a portion of a center console, a portion of a head lining, a portion of a sun visor, a portion of a windshield, or a portion of a window.

The input unit 210 may include a voice input unit 211, a gesture input unit 212, a touch input unit 213, and a mechanical input unit 214.

The voice input unit 211 may convert the user voice input into an electrical signal. The converted electrical signal may be provided to the processor 270 or the controller 170.

The voice input unit 211 may include one or more microphones.

The gesture input unit 212 may convert user gesture input into an electrical signal. The converted electrical signal may be provided to the processor 270 or the controller 170.

The gesture input unit 212 may include at least one of an infrared sensor or an image sensor for sensing user gesture input.

In some embodiments, the gesture input unit 212 may sense three-dimensional user gesture input. To this end, the gesture input unit 212 may include a light output unit for outputting a plurality of infrared beams or a plurality of image sensors.

The gesture input unit 212 may sense the three-dimensional user gesture input through a time of flight (TOF) scheme, a structured light scheme, or a disparity scheme.

The touch input unit 213 may convert user touch input into an electrical signal. The converted electrical signal may be provided to the processor 270 or the controller 170.

The touch input unit 213 may include a touch sensor for sensing user touch input.

In some embodiments, the touch input unit 213 may be integrated into a display 251 in order to realize a touchscreen. The touchscreen may provide both an input interface and an output interface between the vehicle 100 and the user.

The mechanical input unit 214 may include at least one of a button, a dome switch, a jog wheel, or a jog switch. An electrical signal generated by the mechanical input unit 214 may be provided to the processor 270 or the controller 170.

The mechanical input unit 214 may be disposed in a steering wheel, a center fascia, a center console, a cockpit module, a door, etc.

The internal camera 220 may acquire an image inside the vehicle. The processor 270 may sense the state of the user based on the image inside the vehicle. The processor 270 may acquire gaze information of the user from the image inside the vehicle. The processor 270 may sense user gesture from the image inside the vehicle.

The biometric sensing unit 230 may acquire biometric information of the user. The biometric sensing unit 230 may include a sensor capable of acquiring the biometric information of the user, and may acquire fingerprint information, heart rate information, etc. of the user using the sensor. The biometric information may be used to authenticate the user.

The output unit 250 is configured to generate output related to visual sensation, aural sensation, or tactile sensation.

The output unit 250 may include at least one of a display 251, a sound output unit 252, or a haptic output unit 253.

The display 251 may display a graphical object corresponding to various kinds of information.

The display 251 may include at least one of a liquid crystal display (LCD), a thin film transistor-liquid crystal display (TFT LCD), an organic light-emitting diode (OLED), a flexible display, a 3D display, or an e-ink display.

The display 251 may be connected to the touch input unit 213 in a layered structure, or may be formed integrally with the touch input unit, so as to realize a touchscreen.

The display 251 may be realized as a head-up display (HUD). In the case in which the display 251 is realized as the HUD, the display 251 may include a projection module in order to output information through an image projected on the windshield or the window.

The display 251 may include a transparent display. The transparent display may be attached to the windshield or the window.

The transparent display may display a predetermined screen while having predetermined transparency. In order to have transparency, the transparent display may include at least one of a transparent thin film electroluminescent (TFEL) display, a transparent organic light-emitting diode (OLED) display, a transparent Liquid Crystal Display (LCD), a transmissive type transparent display, or a transparent light emitting diode (LED) display. The transparency of the transparent display may be adjusted.

Meanwhile, the user interface device 200 may include a plurality of displays 251a to 251h.

The display 251 may be realized in a portion of the steering wheel, portions of the instrument panel (251a, 251b, and 251e), a portion of the seat (251d), a portion of each pillar (251f), a portion of the door (251g), a portion of the center console, a portion of the head lining, a portion of the sun visor, a portion of the windshield (251c), or a portion of the window (251h).

The sound output unit 252 converts an electrical signal provided from the processor 270 or the controller 170 into an audio signal, and outputs the converted audio signal. To this end, the sound output unit 252 may include one or more speakers.

The haptic output unit 253 may generate tactile output. For example, the haptic output unit 253 may vibrate the steering wheel, a safety belt, and seats 110FL, 110FR, 110RL, and 110RR such that the user recognizes the output.

The processor 270 may control the overall operation of each unit of the user interface device 200.

In some embodiments, the user interface device 200 may include a plurality of processors 270, or may not include the processor 270.

In the case in which the processor 270 is not included in the user interface device 200, the user interface device 200 may be operated under the control of a processor of another device in the vehicle 100 or the controller 170.

Meanwhile, the user interface device 200 may be referred to as a display device for vehicles.

The user interface device 200 may be operated under the control of the controller 170.

The object detection device 300 is a device that detects an object located outside the vehicle 100. The object detection device 300 may generate object information based on sensing data.

The object information may include information about presence or absence of an object, information about the position of the object, information about the distance between the vehicle 100 and the object, and information about the speed of the vehicle 100 relative to the object.

The object may be various bodies related to the operation of the vehicle 100.

Referring to FIGS. 5 and 6, the object O may include a lane OB10, another vehicle OB11, a pedestrian OB12, a two-wheeled vehicle OB13, a traffic signal OB14 and OB15, light, a road, a structure, a speed bump, a geographical body, and an animal.

The lane OB10 may be a traveling lane, a lane next to the traveling lane, or a lane in which an opposite vehicle travels. The lane OB10 may be a concept including left and right lines that define the lane. The lane may be a concept including an intersection.

The vehicle OB11 may be a vehicle that is traveling around the vehicle 100. This vehicle may be a vehicle located within a predetermined distance from the vehicle 100. For example, the vehicle OB11 may be a vehicle that precedes or follows the vehicle 100.

The pedestrian OB12 may be a person located around the vehicle 100. The pedestrian OB12 may be a person located within a predetermined distance from the vehicle 100. For example, the pedestrian OB12 may be a person located on a sidewalk or a roadway.

The two-wheeled vehicle OB13 may be a vehicle that is located around the vehicle 100 and is movable using two wheels. The two-wheeled vehicle OB13 may be a vehicle that is located within a predetermined distance from the vehicle 100 and has two wheels. For example, the two-wheeled vehicle OB13 may be a motorcycle or a bicycle located on a sidewalk or a roadway.

The traffic signal may include a traffic light OB15, a traffic board OB14, and a pattern or text marked on the surface of a road.

The light may be light generated by a lamp of another vehicle. The light may be light generated by a streetlight. The light may be sunlight.

The road may include a road surface, a curve, and a slope, such as an upward slope or a downward slope.

The structure may be a body that is located around a road and fixed to the ground. For example, the structure may include a streetlight, a roadside tree, a building, an electric pole, a signal light, a bridge, a curbstone, and a wall.

The geographical body may include a mountain and a hill.

Meanwhile, the object may be classified as a moving object or a stationary object. For example, the moving object may be a concept including another vehicle that is moving and a pedestrian who is moving. For example, the stationary object may be a concept including a traffic signal, a road, a structure, another vehicle that is in a stopped state, and a pedestrian who is in a stopped state.

The object detection device 300 may include a camera 310, a radar 320, a lidar 330, an ultrasonic sensor 340, an infrared sensor 350, and a processor 370.

In some embodiments, the object detection device 300 may further include components other than the components that are described herein, or may not include some of the components that are described herein.

The camera 310 may be located at an appropriate position outside the vehicle in order to acquire an image outside the vehicle. The camera 310 may be a mono camera, a stereo camera 310a, an around view monitoring (AVM) camera 310b, or a 360-degree camera.

The camera 310 may acquire information of the object, distance information from the object, or speed information relative to the object using various image processing algorithms.

For example, the camera 310 may acquire the distance information from the object and the speed information relative to the object based on a change in the size of the object over time in an acquired image.

For example, the camera 310 may acquire the distance information from the object and the speed information relative to the object through a pin hole model or road surface profiling.

For example, the camera 310 may be disposed in the vehicle so as to be adjacent to a front windshield in order to acquire an image ahead of the vehicle. Alternatively, the camera 310 may be disposed around a front bumper or a radiator grill.

For example, the camera 310 may be disposed in the vehicle so as to be adjacent to a rear glass in order to acquire an image behind the vehicle. Alternatively, the camera 310 may be disposed around a rear bumper, a trunk, or a tail gate.

For example, the camera 310 may be disposed in the vehicle so as to be adjacent to at least one of side windows in order to acquire an image beside the vehicle. Alternatively, the camera 310 may be disposed around a side mirror, a fender, or a door.

The camera 310 may provide the acquired image to the processor 370.

The radar 320 may include an electromagnetic wave transmission unit and an electromagnetic wave reception unit. The radar 320 may be realized using a pulse radar scheme or a continuous wave radar scheme based on an electric wave emission principle. In the continuous wave radar scheme, the radar 320 may be realized using a frequency modulated continuous wave (FMCW) scheme or a frequency shift keying (FSK) scheme based on a signal waveform.

The radar 320 may detect an object based on a time of flight (TOF) scheme or a phase-shift scheme through the medium of an electromagnetic wave, and may detect the position of the detected object, the distance from the detected object, and the speed relative to the detected object.

The radar 320 may be disposed at an appropriate position outside the vehicle in order to sense an object located ahead of, behind, or beside the vehicle.

The lidar 330 may include a laser transmission unit and a laser reception unit. The lidar 330 may be realized using a time of flight (TOF) scheme or a phase-shift scheme.

The lidar 330 may be of a driving type or a non-driving type.

The driving type lidar 330 may be rotated by a motor in order to detect an object around the vehicle 100.

The non-driving type lidar 330 may detect an object located within a predetermined range from the vehicle 100 through light steering. The vehicle 100 may include a plurality of non-driving type lidars 330.

The lidar 330 may detect an object based on a time of flight (TOF) scheme or a phase-shift scheme through the medium of laser light, and may detect the position of the detected object, the distance from the detected object, and the speed relative to the detected object.

The lidar 330 may be disposed at an appropriate position outside the vehicle in order to sense an object located ahead of, behind, or beside the vehicle.

The ultrasonic sensor 340 may include an ultrasonic wave transmission unit and an ultrasonic wave reception unit. The ultrasonic sensor 340 may detect an object based on an ultrasonic wave, and may detect the position of the detected object, the distance from the detected object, and the speed relative to the detected object.

The ultrasonic sensor 340 may be disposed at an appropriate position outside the vehicle in order to sense an object located ahead of, behind, or beside the vehicle.

The infrared sensor 350 may include an infrared transmission unit and an infrared reception unit. The infrared sensor 350 may detect an object based on infrared light, and may detect the position of the detected object, the distance from the detected object, and the speed relative to the detected object.

The infrared sensor 350 may be disposed at an appropriate position outside the vehicle in order to sense an object located ahead of, behind, or beside the vehicle.

The processor 370 may control the overall operation of each unit of the object detection device 300.

The processor 370 may compare data sensed by the camera 310, the radar 320, the lidar 330, the ultrasonic sensor 340, and the infrared sensor 350 with pre-stored data in order to detect or classify an object.

The processor 370 may detect and track an object based on an acquired image. The processor 370 may calculate the distance from the object and the speed relative to the object through an image processing algorithm.

For example, the processor 370 may acquire the distance information from the object and the speed information relative to the object based on a change in the size of the object over time in an acquired image.

For example, the processor 370 may acquire the distance information from the object and the speed information relative to the object through a pin hole model or road surface profiling.

For example, the processor 370 may acquire the distance information from the object and the speed information relative to the object from a stereo image acquired by the stereo camera 310a based on disparity information.

The processor 370 may detect and track an object based on a reflected electromagnetic wave returned as the result of a transmitted electromagnetic wave being reflected by the object. The processor 370 may calculate the distance from the object and the speed relative to the object based on the electromagnetic wave.

The processor 370 may detect and track an object based on reflected laser light returned as the result of transmitted laser light being reflected by the object. The processor 370 may calculate the distance from the object and the speed relative to the object based on the laser light.

The processor 370 may detect and track an object based on a reflected ultrasonic wave returned as the result of a transmitted ultrasonic wave being reflected by the object. The processor 370 may calculate the distance from the object and the speed relative to the object based on the ultrasonic wave.

The processor 370 may detect and track an object based on reflected infrared light returned as the result of transmitted infrared light being reflected by the object. The processor 370 may calculate the distance from the object and the speed relative to the object based on the infrared light.

In some embodiments, the object detection device 300 may include a plurality of processors 370, or may not include the processor 370. For example, each of the camera 310, the radar 320, the lidar 330, the ultrasonic sensor 340, and the infrared sensor 350 may include a processor.

In the case in which the processor 370 is not included in the object detection device 300, the object detection device 300 may be operated under the control of a processor of another device in the vehicle 100 or the controller 170.

The object detection device 300 may be operated under the control of the controller 170.

The communication device 400 is a device for communication with an external device. Here, the external device may be another vehicle, a mobile terminal, or a server.

The communication device 400 may include at least one of a transmission antenna, a reception antenna, a radio frequency (RF) circuit capable of realizing various communication protocols, or an RF element in order to perform communication.

The communication device 400 may include a short range communication unit 410, a position information unit 420, a V2X communication unit 430, an optical communication unit 440, a broadcast transmission and reception unit 450, an intelligent transport system (ITS) communication unit 460, and a processor 470.

In some embodiments, the communication device 400 may further include components other than the components that are described herein, or may not include some of the components that are described herein.

The short range communication unit 410 is a unit for short range communication. The short range communication unit 410 may support short range communication using at least one of Bluetooth™, radio frequency identification (RFID), infrared data association (IrDA), ultra-wideband (UWB), ZigBee, near field communication (NFC), wireless-fidelity (Wi-Fi), Wi-Fi Direct, or wireless universal serial bus (Wireless USB) technology.

The short range communication unit 410 may form a short range wireless area network in order to perform short range communication between the vehicle 100 and at least one external device.

The position information unit 420 is a unit for acquiring position information of the vehicle 100. For example, the position information unit 420 may include a global positioning system (GPS) module or a differential global positioning system (DGPS) module.

The V2X communication unit 430 is a unit for wireless communication with a server (V2I: Vehicle to Infrastructure), another vehicle (V2V: Vehicle to Vehicle), or a pedestrian (V2P: Vehicle to Pedestrian). The V2X communication unit 430 may include an RF circuit capable of realizing protocols for communication with infrastructure (V2I), communication between vehicles (V2V), and communication with a pedestrian (V2P).

The optical communication unit 440 is a unit for performing communication with an external device through the medium of light. The optical communication unit 440 may include an optical transmission unit for converting an electrical signal into an optical signal and transmitting the optical signal and an optical reception unit for converting a received optical signal into an electrical signal.

In some embodiments, the optical transmission unit may be integrated into a lamp included in the vehicle 100.

The broadcast transmission and reception unit 450 is a unit for receiving a broadcast signal from an external broadcasting administration server through a broadcasting channel or transmitting a broadcast signal to the broadcasting administration server. The broadcasting channel may include a satellite channel and a terrestrial channel. The broadcast signal may include a TV broadcast signal, a radio broadcast signal, and a data broadcast signal.

The ITS communication unit 460 may exchange information, data, or a signal with a transport system. The ITS communication unit 460 may provide acquired information or data to the transport system. The ITS communication unit 460 may receive information, data, or a signal from the transport system. For example, the ITS communication unit 460 may receive road traffic information from the transport system, and may provide the same to the controller 170. For example, the ITS communication unit 460 may receive a control signal from the transport system, and may provide the same to the controller 170 or a processor provided in the vehicle 100.

The processor 470 may control the overall operation of each unit of the communication device 400.

In some embodiments, the communication device 400 may include a plurality of processors 470, or may not include the processor 470.

In the case in which the processor 470 is not included in the communication device 400, the communication device 400 may be operated under the control of a processor of another device in the vehicle 100 or the controller 170.

Meanwhile, the communication device 400 may realize a display device for vehicles together with the user interface device 200. In this case, the display device for vehicles may be referred to as a telematics device or an audio video navigation (AVN) device.

The communication device 400 may be operated under the control of the controller 170.

The driving manipulation device 500 is a device that receives user input for driving.

In the manual mode, the vehicle 100 may be operated based on a signal provided by the driving manipulation device 500.

The driving manipulation device 500 may include a steering input device 510, an acceleration input device 530, and a brake input device 570.

The steering input device 510 may receive user input about the advancing direction of the vehicle 100. Preferably, the steering input device 510 is configured in the form of a wheel, which is rotated for steering input. In some embodiments, the steering input device 510 may be configured in the form of a touchscreen, a touch pad, or a button.

The acceleration input device 530 may receive user input for acceleration of the vehicle 100. The brake input device 570 may receive user input for deceleration of the vehicle 100. Preferably, each of the acceleration input device 530 and the brake input device 570 is configured in the form of a pedal. In some embodiments, the acceleration input device or the brake input device may be configured in the form of a touchscreen, a touch pad, or a button.

The driving manipulation device 500 may be operated under the control of the controller 170.

The vehicle driving device 600 is a device that electrically controls driving of each device in the vehicle 100.

The vehicle driving device 600 may include a powertrain driving unit 610, a chassis driving unit 620, a door/window driving unit 630, a safety apparatus driving unit 640, a lamp driving unit 650, and an air conditioner driving unit 660.

In some embodiments, the vehicle driving device 600 may further include components other than the components that are described herein, or may not include some of the components that are described herein.

Meanwhile, the vehicle driving device 600 may include a processor. Each unit of the vehicle driving device 600 may include a processor.

The powertrain driving unit 610 may control the operation of a powertrain device.

The powertrain driving unit 610 may include a power source driving unit 611 and a gearbox driving unit 612.

The power source driving unit 611 may control a power source of the vehicle 100.

For example, in the case in which the power source is an engine based on fossil fuel, the power source driving unit 611 may electronically control the engine. As a result, output torque of the engine may be controlled. The power source driving unit 611 may adjust the output torque of the engine under the control of the controller 170.

For example, in the case in which the power source is a motor based on electric energy, the power source driving unit 611 may control the motor. The power source driving unit 611 may adjust rotational speed, torque, etc. of the motor under the control of the controller 170.

The gearbox driving unit 612 may control a gearbox.

The gearbox driving unit 612 may adjust the state of the gearbox. The gearbox driving unit 612 may adjust the state of the gearbox to drive D, reverse R, neutral N, or park P.

Meanwhile, in the case in which the power source is an engine, the gearbox driving unit 612 may adjust the engagement between gears in the state of forward movement D.

The chassis driving unit 620 may control the operation of a chassis device.

The chassis driving unit 620 may include a steering driver 621, a brake driving unit 622, and a suspension driving unit 623.

The steering driver 621 may electronically control a steering apparatus in the vehicle 100. The steering driver 621 may change the advancing direction of the vehicle.

The brake driving unit 622 may electronically control a brake apparatus in the vehicle 100. For example, the brake driving unit may control the operation of a brake disposed at each wheel in order to reduce the speed of the vehicle 100.

Meanwhile, the brake driving unit 622 may individually control a plurality of brakes. The brake driving unit 622 may perform control such that braking forces applied to the wheels are different from each other.

The suspension driving unit 623 may electronically control a suspension apparatus in the vehicle 100. For example, in the case in which the surface of a road is irregular, the suspension driving unit 623 may control the suspension apparatus in order to reduce vibration of the vehicle 100.

Meanwhile, the suspension driving unit 623 may individually control a plurality of suspensions.

The door/window driving unit 630 may electronically control a door apparatus or a window apparatus in the vehicle 100.

The door/window driving unit 630 may include a door driving unit 631 and a window driving unit 632.

The door driving unit 631 may control the door apparatus. The door driving unit 631 may control opening or closing of a plurality of doors included in the vehicle 100. The door driving unit 631 may control opening or closing of a trunk or a tail gate. The door driving unit 631 may control opening or closing of a sunroof.

The window driving unit 632 may electronically control the window apparatus. The window driving unit may control opening or closing of a plurality of windows included in the vehicle 100.

The safety apparatus driving unit 640 may electronically control various safety apparatuses in the vehicle 100.

The safety apparatus driving unit 640 may include an airbag driving unit 641, a seatbelt driving unit 642, and a pedestrian protection apparatus driving unit 643.

The airbag driving unit 641 may electronically control an airbag apparatus in the vehicle 100. For example, when danger is sensed, the airbag driving unit 641 may perform control such that an airbag is inflated.

The seatbelt driving unit 642 may electronically control a seatbelt apparatus in the vehicle 100.

For example, when danger is sensed, the seatbelt driving unit 642 may perform control such that passengers are fixed to the 110FL, 110FR, 110RL, and 110RR using seatbelts.

The pedestrian protection apparatus driving unit 643 may electronically control a hood lift and a pedestrian airbag. For example, when collision with a pedestrian is sensed, the pedestrian protection apparatus driving unit 643 may perform control such that the hood lift is raised and the pedestrian airbag is inflated.

The lamp driving unit 650 may electronically control various lamp apparatuses in the vehicle 100.

The air conditioner driving unit 660 may electronically control an air conditioner in the vehicle 100. For example, in the case in which the temperature in the vehicle is high, the air conditioner driving unit 660 may perform control such that the air conditioner is operated to supply cold air into the vehicle.

The vehicle driving device 600 may include a processor. Each unit of the vehicle driving device 600 may include a processor.

The vehicle driving device 600 may be operated under the control of the controller 170.

The operation system 700 is a system that controls various operations of the vehicle 100. The operation system 700 may be operated in the autonomous mode.

The operation system 700 may include a traveling system 710, an exiting system 740, or a parking system 750.

In some embodiments, the operation system 700 may further include components other than the components that are described herein, or may not include some of the components that are described herein.

Meanwhile, the operation system 700 may include a processor. Each unit of the operation system 700 may include a processor.

Meanwhile, in some embodiments, the operation system 700 may be a low-level concept of the controller 170 in the case of being realized in the form of software.

Meanwhile, in some embodiments, the operation system 700 may be a concept including at least one of the user interface device 200, the object detection device 300, the communication device 400, the driving manipulation device 500, the vehicle driving device 600, the navigation system 770, the sensing unit 120, or the controller 170.

The traveling system 710 may perform traveling of the vehicle 100.

The traveling system 710 may receive navigation information from the navigation system 770, and may provide a control signal to the vehicle driving device 600 in order to perform traveling of the vehicle 100.

The traveling system 710 may receive object information from the object detection device 300, and may provide a control signal to the vehicle driving device 600 in order to perform traveling of the vehicle 100.

The traveling system 710 may receive a signal from an external device through the communication device 400, and may provide a control signal to the vehicle driving device 600 in order to perform traveling of the vehicle 100.

The traveling system 710 may be a system concept including at least one of the user interface device 200, the object detection device 300, the communication device 400, the driving manipulation device 500, the vehicle driving device 600, the navigation system 770, the sensing unit 120, or the controller 170 in order to perform traveling of the vehicle 100.

The traveling system 710 may be referred to as a vehicle traveling control device.

The exiting system 740 may perform exiting of the vehicle 100.

The exiting system 740 may receive navigation information from the navigation system 770, and may provide a control signal to the vehicle driving device 600 in order to perform exiting of the vehicle 100.

The exiting system 740 may receive object information from the object detection device 300, and may provide a control signal to the vehicle driving device 600 in order to perform exiting of the vehicle 100.

The exiting system 740 may receive a signal from an external device through the communication device 400, and may provide a control signal to the vehicle driving device 600 in order to perform exiting of the vehicle 100.

The exiting system 740 may be a system concept including at least one of the user interface device 200, the object detection device 300, the communication device 400, the driving manipulation device 500, the vehicle driving device 600, the navigation system 770, the sensing unit 120, or the controller 170 in order to perform exiting of the vehicle 100.

The exiting system 740 may be referred to as a vehicle exiting control device.

The parking system 750 may perform parking of the vehicle 100.

The parking system 750 may receive navigation information from the navigation system 770, and may provide a control signal to the vehicle driving device 600 in order to perform parking of the vehicle 100.

The parking system 750 may receive object information from the object detection device 300, and may provide a control signal to the vehicle driving device 600 in order to perform parking of the vehicle 100.

The parking system 750 may receive a signal from an external device through the communication device 400, and may provide a control signal to the vehicle driving device 600 in order to perform parking of the vehicle 100.

The parking system 750 may be a system concept including at least one of the user interface device 200, the object detection device 300, the communication device 400, the driving manipulation device 500, the vehicle driving device 600, the navigation system 770, the sensing unit 120, or the controller 170 in order to perform parking of the vehicle 100.

The parking system 750 may be referred to as a vehicle parking control device.

The navigation system 770 may provide navigation information. The navigation information may include at least one of map information, information about a set destination, information about a route based on the setting of the destination, information about various objects on the route, lane information, or information about the current position of the vehicle.

The navigation system 770 may include a memory and a processor. The memory may store the navigation information. The processor may control the operation of the navigation system 770.

In some embodiments, the navigation system 770 may receive information from an external device through the communication device 400 in order to update pre-stored information.

In some embodiments, the navigation system 770 may be classified as a low-level component of the user interface device 200.

The sensing unit 120 may sense the state of the vehicle. The sensing unit 120 may include an inertial navigation unit (IMU) sensor, a collision sensor, a wheel sensor, a speed sensor, a slope sensor, a weight sensor, a heading sensor, a position module, a vehicle forward/rearward movement sensor, a battery sensor, a fuel sensor, a tire sensor, a steering wheel rotation sensor, an in-vehicle temperature sensor, an in-vehicle humidity sensor, an ultrasonic sensor, an illumination sensor, an accelerator pedal position sensor, and a brake pedal position sensor.

Meanwhile, the inertial navigation unit (IMU) sensor may include one or more of an acceleration sensor, a gyro sensor, and a magnetic sensor.

The sensing unit 120 may acquire vehicle orientation information, vehicle motion information, vehicle yaw information, vehicle roll information, vehicle pitch information, vehicle collision information, vehicle direction information, vehicle position information (GPS information), vehicle angle information, vehicle speed information, vehicle acceleration information, vehicle tilt information, vehicle forward/rearward movement information, battery information, fuel information, tire information, vehicle lamp information, in-vehicle temperature information, in-vehicle humidity information, and a sensing signal, such as a steering wheel rotation angle, illumination outside the vehicle, pressure applied to an accelerator pedal, and pressure applied to a brake pedal.

In addition, the sensing unit 120 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, and a crank angle sensor (CAS).

The sensing unit 120 may generate vehicle state information based on sensing data. The vehicle state information may be information generated based on data sensed by various sensors provided in the vehicle.

For example, the vehicle state information may include vehicle orientation information, vehicle speed information, vehicle tilt information, vehicle weight information, vehicle direction information, vehicle battery information, vehicle fuel information, information about the air pressure of tires of the vehicle, vehicle steering information, in-vehicle temperature information, in-vehicle humidity information, pedal position information, and vehicle engine temperature information.

The interface 130 may serve as a path between the vehicle 100 and various kinds of external devices connected thereto. For example, the interface 130 may include a port connectable to a mobile terminal, and may be connected to the mobile terminal via the port. In this case, the interface 130 may exchange data with the mobile terminal.

Meanwhile, the interface 130 may serve as a path for supplying electrical energy to the mobile terminal connected thereto. In the case in which the mobile terminal is electrically connected to the interface 130, the interface 130 may provide electrical energy, supplied from the power supply unit 190, to the mobile terminal under the control of the controller 170.

The memory 140 is electrically connected to the controller 170. The memory 140 may store basic data about the units, control data necessary to control the operation of the units, and data that are input and output. In a hardware aspect, the memory 140 may be any of various storage devices, such as a ROM, a RAM, an EPROM, a flash drive, and a hard drive. The memory 140 may store various data necessary to perform the overall operation of the vehicle 100, such as a program for processing or control of the controller 170.

In some embodiments, the memory 140 may be integrated into the controller 170, or may be realized as a low-level component of the controller 170.

The controller 170 may control the overall operation of each unit in the vehicle 100. The controller 170 may be referred to as an electronic control unit (ECU).

The power supply unit 190 may supply power necessary to operate each component under the control of the controller 170. In particular, the power supply unit 190 may receive power from a battery in the vehicle.

One or more processors and the controller 170 included in the vehicle 100 may be realized using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

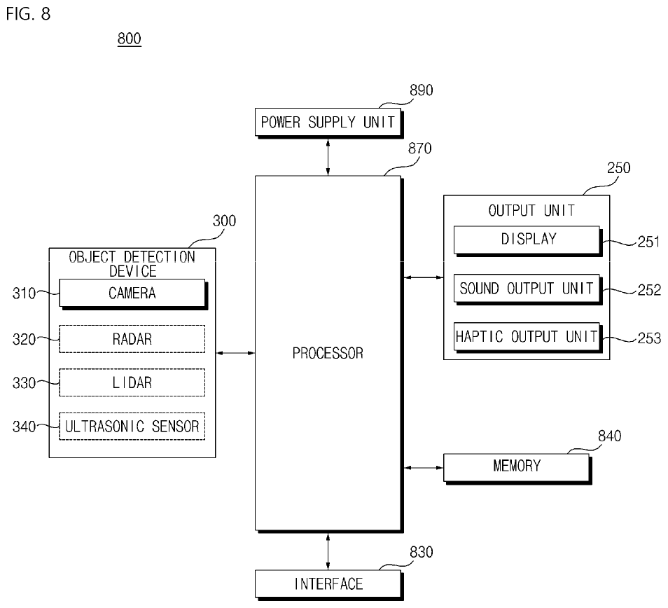

FIG. 8 is a block diagram of an driver assistance apparatus according to an embodiment of the present disclosure.

The vehicle 100 may include an driver assistance apparatus 800 and a plurality of wheels configured to be driven based on a control signal provided by the driver assistance apparatus 800.

Referring to FIG. 8, the driver assistance apparatus 800 may include an object detection device 300, an output unit 250, an interface 830, a memory 840, a processor 870, and a power supply unit 890.

The description of the object detection device 300 given with reference to FIGS. 1 to 7 may be applied to the object detection device 300.

The object detection device 300 may include a camera 310.

The camera 310 may capture an image around the vehicle.

The camera 310 may capture an image of an area that provides a blind zone to a driver.

For example, the camera 310 may capture an image of the left rear and the right rear.

The camera 310 may be attached to at least one of a side mirror, a front door, a rear door, a fender, a bumper, an A pillar, a B pillar, or a C pillar in order to capture an image of the side rear of the vehicle.

The camera 310 may be a camera constituting an around view monitoring (AVM) device.

The description of the output unit 250 of the user interface device 200 given with reference to FIGS. 1 to 7 may be applied to the output unit 250.

Although the output unit 250 has been described as a component of the user interface device 200 with reference to FIGS. 1 to 7, the output unit 250 may be classified as a component of the driver assistance apparatus 800

The output unit 250 may include a display 251, a sound output unit 252, and a haptic output unit 253.

The output unit 250 may output an alarm under the control of the processor 870.

The display 251 may output a visual alarm under the control of the processor 870.

The display 251 may be realized as a head-up display (HUD), or may be disposed in a portion of the instrument panel.

In some embodiments, the display 251 may be include in a portion of one of the side mirror, the A pillar, the windshield, a room mirror, and the window.

The sound output unit 252 may output an audible alarm under the control of the processor 870.

The haptic output unit 253 may output a tactile alarm under the control of the processor 870.

The output unit 250 may distinctively output the visual alarm, the audible alarm, or the tactile alarm based on traveling status information.

For example, in the case in which object information is acquired, the output unit 250 may output the visual alarm or the audible alarm under the control of the processor 870.

For example, in the case in which object information is acquired in the state in which turn signal input is received, the output unit 250 may output the tactile alarm under the control of the processor 870.

The interface 830 may exchange information, data, or a signal with another device or system included in the vehicle 100.

Specifically, the interface 830 may exchange information, data, or a signal with at least one of the user interface device 200, the communication device 400, the driving manipulation device 500, the vehicle driving device 600, the operation system 700, the navigation system 770, the sensing unit 120, the memory 140, or the controller 170.

For example, the interface 830 may receive information about the speed of the vehicle 100 from the sensing unit 120.

For example, the interface 830 may receive illumination information around the vehicle 100 from the sensing unit 120.

For example, the interface 830 may receive steering input information from the driving manipulation device 500.

For example, the interface 830 may provide a control signal generated by the processor 870 to the vehicle driving device 600.

The memory 840 is electrically connected to the processor 870. The memory 840 may store basic data about the units, control data necessary to control the operation of the units, and data that are input and output. In a hardware aspect, the memory 840 may be any of various storage devices, such as a ROM, a RAM, an EPROM, a flash drive, and a hard drive. The memory 840 may store various data necessary to perform the overall operation of the driver assistance apparatus 800, such as a program for processing or control of the processor 870.

The processor 870 may be electrically connected to each unit of the driver assistance apparatus 800.

The processor 870 may control the overall operation of each unit of the driver assistance apparatus 800.

The processor 870 may adjust the frame rate of the camera 310.

The processor 870 may adjust the frame rate of the camera 310 in order to control the exposure of the camera 310.

The processor 870 may adjust the frame rate of the camera 310 in order to cause motion blur in an image acquired through the camera 310.

For example, the processor 870 may lower the frame rate of the camera 310 in order to lengthen the exposure of the camera 310. In this case, large motion blur occurs in the background, the speed of the vehicle 100 relative to which is high. No motion blur occurs on another vehicle in an adjacent lane, the speed of the vehicle 100 relative to which is low.

The processor 870 may receive an image around the vehicle acquired by the camera 310.

The processor 870 may image-process the image around the vehicle.

The processor 870 may detect an object based on an image in which motion blur occurs.

For example, the processor 870 may detect an object in an image in which motion blur occurs using a blur measure or a sharpness measure.

The processor 870 may determine whether the detected object is located in a blind zone.

The processor 870 may provide a control signal based on determination as to whether the detected object is located in the blind zone.

Upon determining that the detected object is located in the blind zone, the processor 870 may provide a control signal for outputting an alarm to the output unit 250.

Upon determining that the detected object is located in the blind zone, the processor 870 may provide a control signal for controlling the vehicle to the vehicle driving device 600.

The processor 870 may receive information about the speed of the vehicle 100 from the sensing unit 120 through the interface 830.

The processor 870 may set the frame rate of the camera 310 based on the information about the speed of the vehicle 100.

For example, the processor 870 may perform control such that, the higher the speed of the vehicle, the higher the frame rate of the camera 310. In the case in which the speed of the vehicle is high, blur occurs on most structural bodies other than an object to be detected. Even in the case in which the exposure of the camera 310 is shortened, therefore, it is possible to detect an object moving at a speed similar to the speed of the vehicle 100.

For example, the processor 870 may perform control such that, the lower the speed of the vehicle, the lower the frame rate of the camera 310. In the case in which the speed of the vehicle is low, blur hardly occurs on structural bodies other than an object to be detected. Consequently, it is necessary to lengthen the exposure of the camera 310.

The processor 870 may receive illumination information around the vehicle 100 from the sensing unit 120 through the interface 830.

The processor 870 may set the frame rate of the camera 310 based on the illumination information around the vehicle.

For example, the processor 870 may perform control such that, the lower the value of illumination around the vehicle 100, the lower the frame rate of the camera 310. In the case in which the amount of light provided at night is insufficient, much noise is generated and a dark image is captured if the exposure of the camera 310 is shortened. Consequently, it is necessary to lengthen the exposure of the camera.

For example, the processor 870 may perform control such that, the higher the value of illumination around the vehicle 100, the higher the frame rate of the camera 310.

The processor 870 may generate information about the relative speed between the vehicle 100 and the object based on the frame rate of the camera 310 and the extent of motion blur occurring on the detected object.

The processor 870 may measure the extent of motion blur occurring on the detected object using a predetermined image processing algorithm.

The processor 870 may generate information about the relative speed between the vehicle 100 and the object based on the extent of motion blur.

The processor 870 may generate information about the relative speed between the vehicle 100 and the object based on the frame rate of the camera 310 at the time at which the image is acquired and the extent of motion blur of the object in the image.

In some embodiments, the processor 870 may generate information about the relative speed between the vehicle 100 and the object based on sensing data generated by at least one of the radar, the lidar, or the ultrasonic sensor.

The processor 870 may set the frame rate of the camera 310 based on the information about the relative speed between the vehicle 100 and the object.

For example, the processor 870 may perform control such that, the higher the relative speed between the vehicle 100 and the object, the higher the frame rate of the camera. In the case in which the relative speed between the vehicle 100 and the object increases, the frame rate of the camera may be adjusted to shorten the exposure of the camera, whereby it is possible to obtain a clearer object image.

For example, the processor 870 may perform control such that, the lower the relative speed between the vehicle 100 and the object, the lower the frame rate of the camera.

The higher the frame rate of the camera, the larger processing time and processing capacity are required. Consequently, it is advantageous to lower the frame rate of the camera as much as possible.

The processor 870 may classify another vehicle traveling in an adjacent lane from among a plurality of objects detected based on the image in which the motion blur occurs.

The processor 870 may classify only an object that becomes an alarm output target from among a plurality of objects.

For example, the processor 870 may exclude other vehicles traveling in lanes other than the adjacent lane.

For example, the processor 870 may exclude an object located on a sidewalk.

For example, the processor 870 may exclude another vehicle opposite the vehicle 100.

For example, the processor 870 may exclude another vehicle located behind the vehicle 100 in a traveling lane when the vehicle travels along a curve.

In some embodiments, the processor 870 may classify an object based on information about the route of the vehicle 100.

For example, in the case in which the vehicle 100 is expected to turn left, the processor may exclude another vehicle traveling in an adjacent right lane.

For example, in the case in which the vehicle 100 is expected to turn right, the processor may exclude another vehicle traveling in an adjacent left lane.

The processor 870 may perform cropping the detected object.

The processor 870 may perform control such that an image of the cropped object is displayed on the display 251.

The processor 870 may set the direction in which the object image is displayed based on information about the direction in which the object approaches the vehicle 100.

The processor 870 may generate information about the direction in which the object approaches the vehicle 100 based on the image acquired through the camera 310.

The processor 870 may set the direction in which the object image is displayed based on the direction information of the object.

The processor 870 may set the size of the object image based on information about the distance between the object and the vehicle 100.

The processor 870 may generate information about the distance between the object and the vehicle 100 based on the image acquired through the camera 310.

The processor 870 may generate information about the distance between the object and the vehicle 100 based on the frame rate of the camera 310 and the extent of motion blur.

In some embodiments, the processor 870 may generate information about the distance between the object and the vehicle 100 based on sensing data of at least one of the radar, the lidar, or the ultrasonic sensor.

The processor 870 may perform control such that, the smaller the value of the distance between the object and the vehicle 100, the larger the size of the object image.

The processor 870 may determine whether motion blur occurs in the cropped object image.

Upon determining that motion blur occurs in the cropped object image, the processor 870 may adjust the frame rate of the camera 310.

In this case, the processor 870 may acquire information about the relative speed between the vehicle 100 and the object based on the motion blur occurring in the cropped object image. The processor 870 may adjust the frame rate of the camera 310 based on the relative speed information. It is possible to obtain a clear object image by adjusting the frame rate of the camera.

The processor 870 may receive steering input information through the interface 830.

The processor 870 may apply a graphical effect to the object image based on the steering information.

In the case in which steering is input in a direction approaching the object, the processor 870 may be perform control such that the object image is highlighted.

Upon determining that the detect object is located in the blind zone, the processor 870 may provide a control signal for controlling steering to the steering driver 621 through the interface 830.

The power supply unit 890 may supply power necessary to operate each component under the control of the processor 870. In particular, the power supply unit 890 may receive power from a battery in the vehicle.

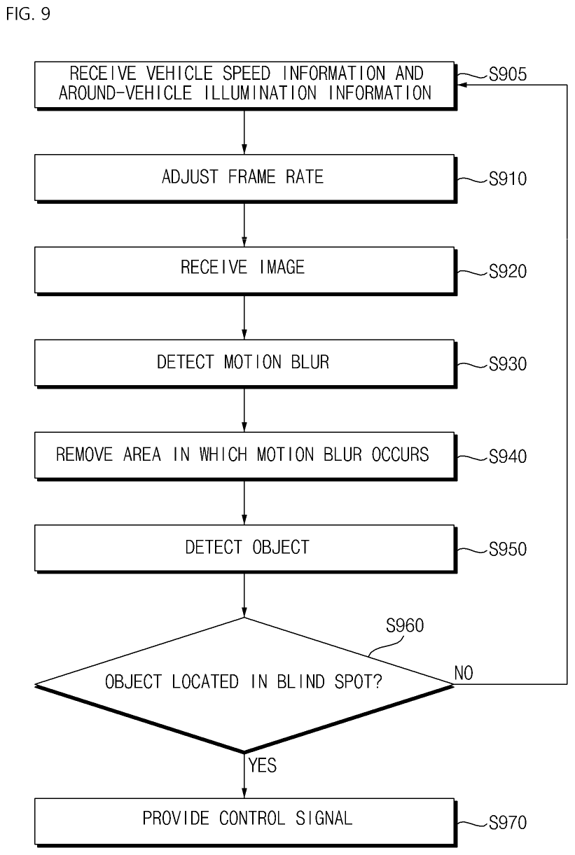

FIG. 9 is a flowchart of the driver assistance apparatus according to the embodiment of the present disclosure.

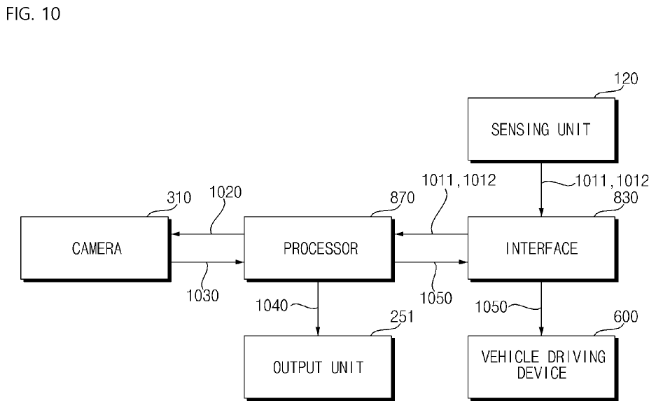

FIG. 10 is an information flowchart of the driver assistance apparatus according to the embodiment of the present disclosure.

Referring to FIGS. 9 and 10, the processor 870 may receive at least one of vehicle speed information 1011 or around-vehicle illumination information 1012 from the sensing unit 120 through the interface 830 (S905).

The processor 870 may adjust the frame rate of the camera 310 based on at least one of the vehicle speed information or the around-vehicle illumination information (S905).

The processor 870 may provide a control signal 1020 for adjusting the frame rate of the camera 310 to the camera 310.

For example, the processor 870 may perform control such that, the higher the speed of the vehicle 100, the higher the frame rate of the camera 310.

For example, the processor 870 may perform control such that, the lower the speed of the vehicle 100, the lower the frame rate of the camera 310.

For example, the processor 870 may perform control such that, the lower the value of illumination around the vehicle 100, the lower the frame rate of the camera 310.

For example, the processor 870 may perform control such that, the higher the value of illumination around the vehicle 100, the higher the frame rate of the camera 310.

The processor 870 may receive an image acquired based on the adjusted frame rate of the camera (S920).

The processor 870 may receive image data 1030 from the camera 310.

Here, the image may be an image in which motion blur occurs.

The processor 870 may detect motion blur (S930).

The processor 870 may detect motion blur based on the edge of an object.

For example, the processor 870 may determine an area in which no edge is detected to be an area in which motion blur occurs.

Motion blur occurs in an object configured such that the difference in relative speed between the object and the vehicle 100 is a first reference value or more.

For example, when the vehicle 100 travels at a first speed or higher, motion blur may occur on objects, such as a building, a pedestrian, a streetlight, and a roadside tree, in an image.

No motion blur occurs in an object configured such that the difference in relative speed between the object and the vehicle 100 is a second reference value or less.

For example, no motion blur may occur on another vehicle traveling in an adjacent lane in an image.

The processor 870 may remove an area in which motion blur occurs (S940).

The processor 870 may detect an object (S950).

Here, the object may be an object in which no motion blur occurs.

For example, the processor 870 may detect another vehicle traveling in an adjacent lane.

The processor 870 may determine whether the detected object is located in a blind spot (S960).

Upon determining that the object is located in the blind spot, the processor 870 may provide a control signal (S970).

For example, the processor 870 may provide a control signal 1040 for outputting an alarm to the output unit 250.

For example, the processor 870 may provide a control signal 1050 for controlling the vehicle to the vehicle driving device 600 through the interface 830.

The control signal for controlling the vehicle may include at least one of a signal for controlling steering, a signal for acceleration, or a signal for deceleration.

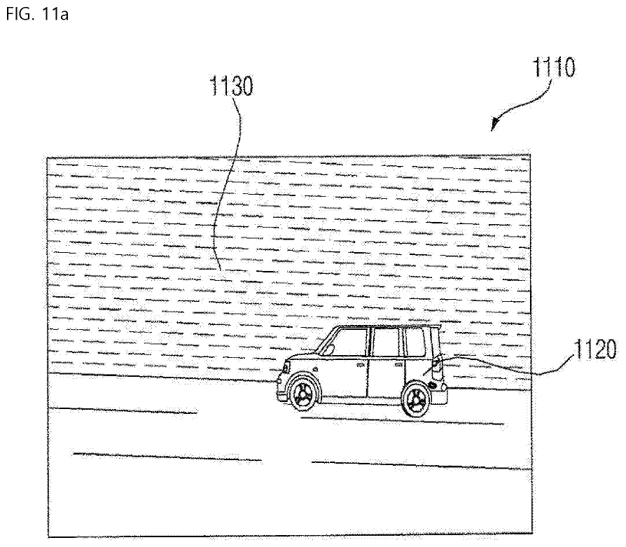

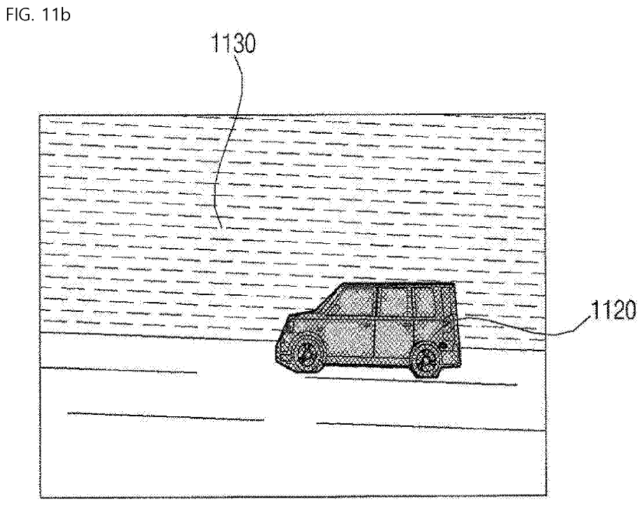

FIGS. 11a and 11b are views exemplarily showing an image acquired through the camera according to an embodiment of the present disclosure.

As exemplarily shown in FIG. 11a, the processor 870 may adjust the frame rate of the camera 310.

The processor 870 may adjust the degree of exposure through adjustment of the frame rate of the camera.

The processor 870 may adjust the frame rate of the camera 310. In this case, exposure is lengthened.

The processor 870 may receive data about an image 1110 captured based on the set frame rate of the camera.

For example, the camera 310 may capture an image of the side (or the side rear) of the vehicle.

In this case, motion blur occurs on an object 1130 configured such that the difference in relative speed between the object and the vehicle 100 is large.

In this case, no or little motion blur occurs on an object 1120 configured such that the difference in relative speed between the object and the vehicle 100 is small.

Meanwhile, the processor 870 may determine whether motion blur occurs based on whether an edge is detected.

The processor 870 may determine that no motion blur occurs on an object, the edge of which is detected.

The processor 870 may determine that motion blur occurs on an object, the edge of which is not detected.

As exemplarily shown in FIG. 11b, the processor 870 may detect an object 1120, on which no or little motion blur occurs.

The processor 870 may detect an object using a blur measure or a sharpness measure.

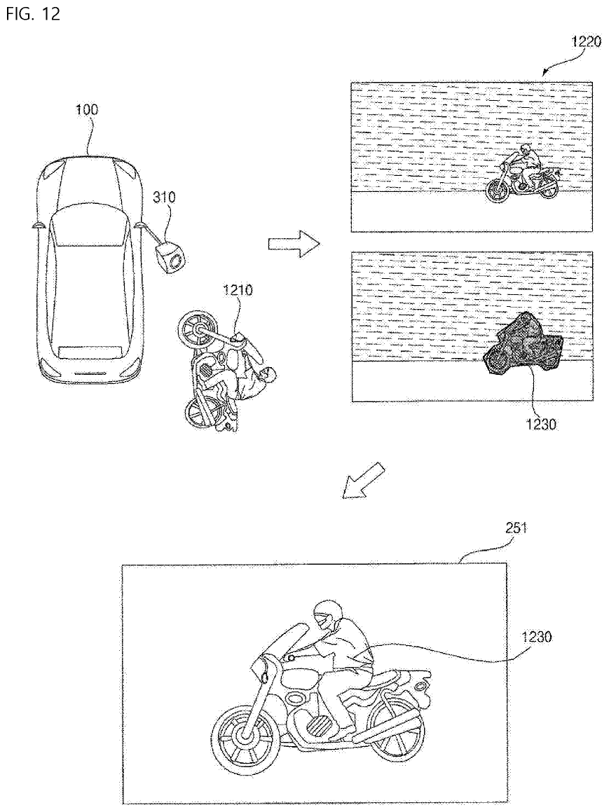

FIG. 12 is a reference view illustrating an operation of displaying an object image detected according to an embodiment of the present disclosure.

Referring to FIG. 12, the camera 310 may be attached to the side surface of the vehicle 100.

The camera 310 may capture an image of the side of the vehicle 100.

A captured image 1220 may include an object 1230.

The captured image 1220 may be an image in which motion blur occurs by controlling the frame rate of the camera 310.

An object 1230, which impedes the vehicle 100 changing lanes, may appear clear in the image 1220.

Motion blur may occur on an object that does not impede the vehicle 100 changing lanes in the image 1220.

The processor 870 may perform cropping the object 1230.

The processor 870 may control the display 251 such that an image of the cropped object 1230 is displayed on the display 251.

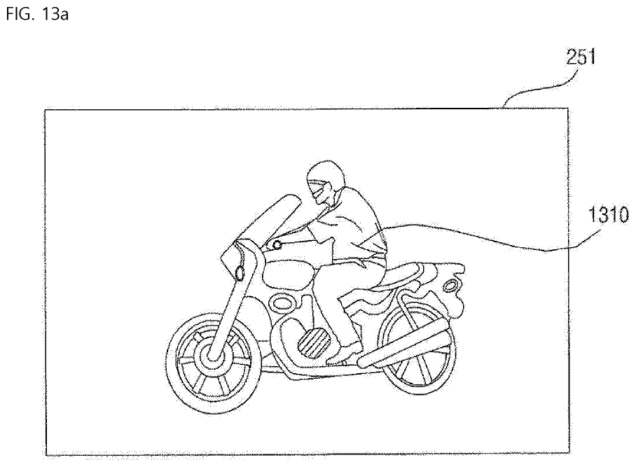

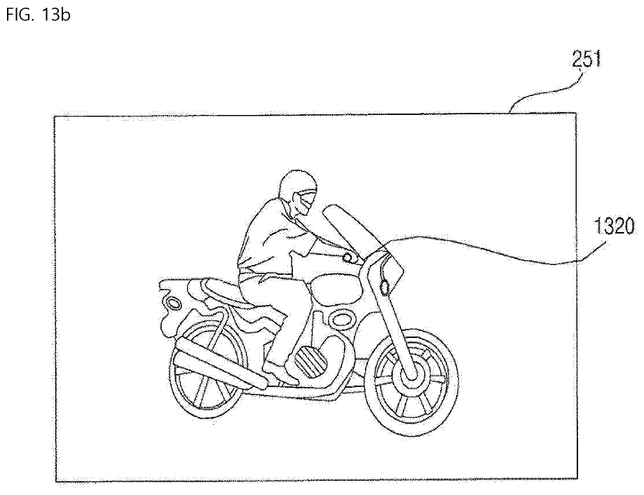

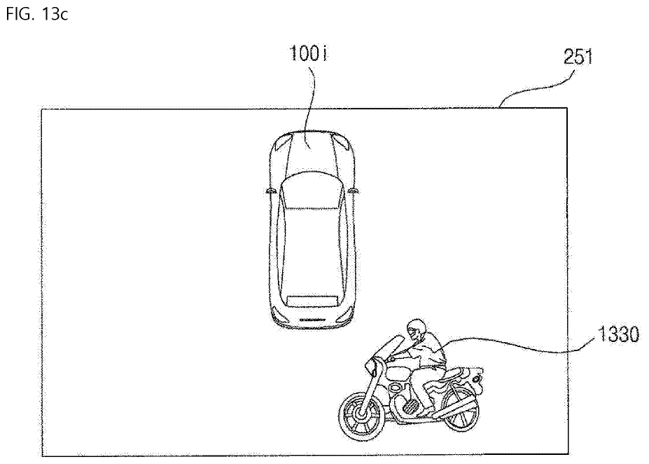

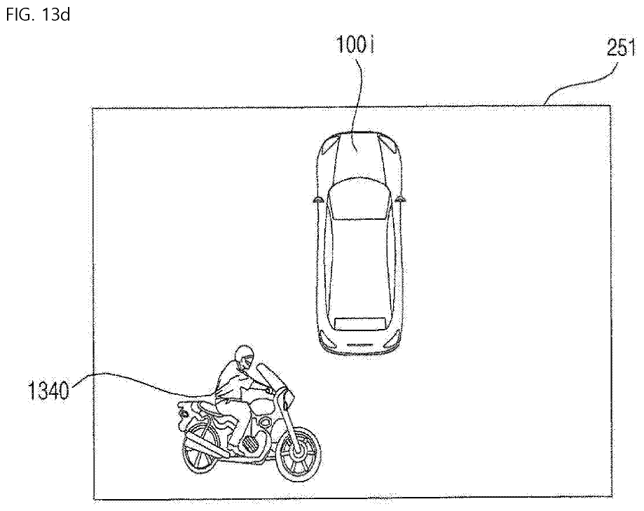

FIGS. 13a to 16 are views showing examples in which images are displayed according to an embodiment of the present disclosure.

As exemplarily shown in FIGS. 13a and 13b, the processor 870 may set the direction in which an object image is displayed based on information about the direction in which an object approaches the vehicle 100.

As exemplarily shown in FIG. 13a, in the case in which an object approaches the right of the vehicle 100 from the right rear thereof, the processor 870 may control the display 251 such that an object image 1310 is displayed so as to face from the right to the left.

As exemplarily shown in FIG. 13b, in the case in which an object approaches the right of the vehicle 100 from the left rear thereof, the processor 870 may control the display 251 such that an object image 1320 is displayed so as to face from the left to the right.

As exemplarily shown in FIG. 13c, in the case in which an object approaches the right of the vehicle 100 from the right rear thereof, the processor 870 may control the display 251 such that an object image 1330 approaching a vehicle image 100i from the right rear of the vehicle image 100i is displayed. Here, the object image 1330 may be a cropped object image.

As exemplarily shown in FIG. 13d, in the case in which an object approaches the left of the vehicle 100 from the left rear thereof, the processor 870 may control the display 251 such that an object image 1330 approaching a vehicle image 100i from the left rear of the vehicle image 100i is displayed. Here, the object image 1330 may be a cropped object image.

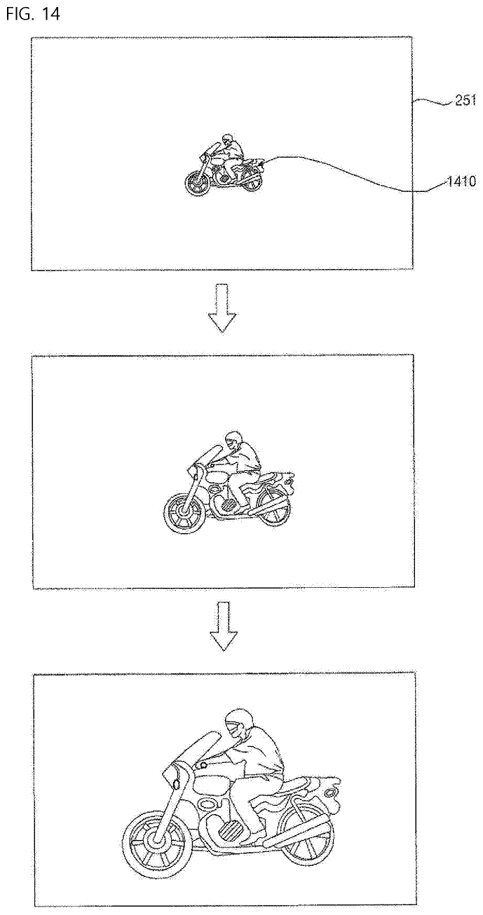

As exemplarily shown in FIG. 14, the processor 870 may adjust the size of an object image 1410 based on the distance between the vehicle 100 and an object.

In the case in which the distance between the vehicle 100 and the object gradually decreases, the processor 870 may display the object image 1410 while gradually increasing the size thereof.

In the case in which the distance between the vehicle 100 and the object gradually increases, the processor 870 may display the object image 1410 while gradually decreasing the size thereof.

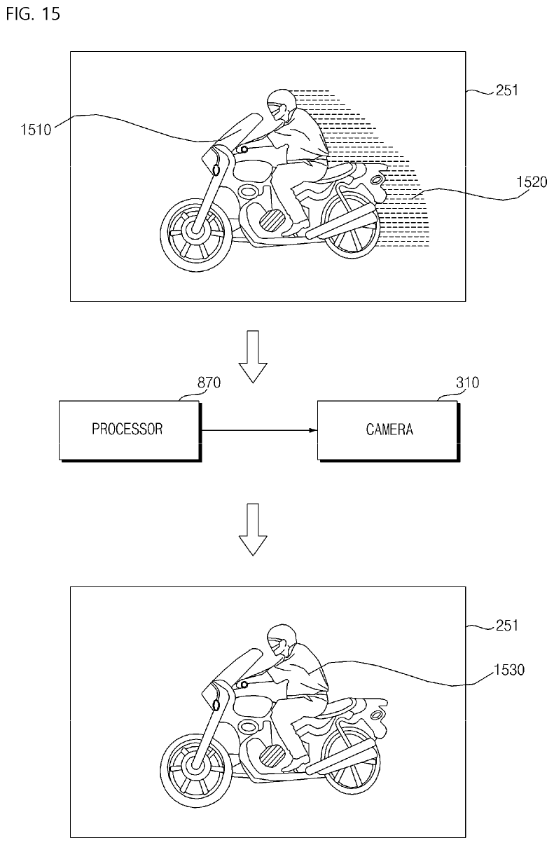

As exemplarily shown in FIG. 15, the processor 870 may determine whether motion blur 1520 occurs in an object image 1510.

Upon determining that the motion blur 1520 occurs, the processor 870 may adjust the frame rate of the camera 310.

The processor 870 may acquire information about the relative speed between the vehicle 100 and an object based on the frame rate of the camera and the extent of motion blur occurring in the cropped object image.

The processor 870 may adjust the frame rate of the camera 310 based on the relative speed information.

For example, upon determining that the motion blur 1520 occurs, the processor 870 may perform control such that the frame rate of the camera 310 is increased.

The processor 870 may perform cropping an object image 1530, which becomes clear by adjusting the frame rate of the camera, and may display the same on the display 251.

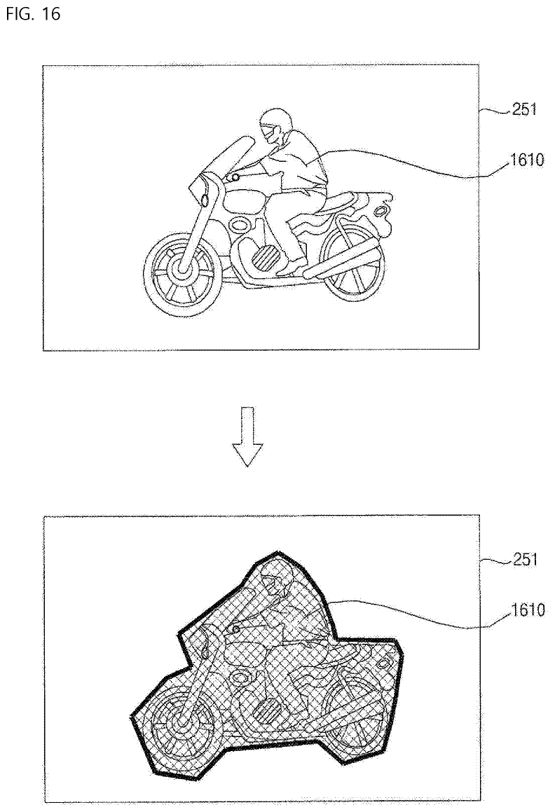

As exemplarily shown in FIG. 16, the processor 870 may apply a graphical effect to an object image 1610 based on steering information. For example, the processor 870 may adjust at least one of the color, the size, or the transparency of the object image 1610. For example, the processor 870 may highlight the object image 1610.

In the case in which steering input to the right is received in the state in which an object approaches the vehicle 100 from the right rear thereof, the processor 870 may apply a graphical effect to the object image 1610.

In the case in which steering input to the left is received in the state in which an object approaches the vehicle 100 from the left rear thereof, the processor 870 may apply a graphical effect to the object image 1610.

The processor 870 may apply a graphical effect to an object image 1610 based on information about the distance between the vehicle 100 and the object. For example, the processor 870 may adjust at least one of the color, the size, or the transparency of the object image 1610. For example, the processor 870 may highlight the object image 1610.

The present disclosure as described above may be implemented as code that can be written on a computer-readable medium in which a program is recorded and thus read by a computer. The computer-readable medium includes all kinds of recording devices in which data is stored in a computer-readable manner. Examples of the computer-readable recording medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disc, and an optical data storage device. In addition, the computer-readable medium may be implemented as a carrier wave (e.g. data transmission over the Internet). In addition, the computer may include a processor or a controller. Thus, the above detailed description should not be construed as being limited to the embodiments set forth herein in all terms, but should be considered by way of example. The scope of the present disclosure should be determined by the reasonable interpretation of the accompanying claims and all changes in the equivalent range of the present disclosure are intended to be included in the scope of the present disclosure.

### DESCRIPTION OF REFERENCE NUMERALS

100: Vehicle
800: Driver assistance apparatus

1. An driver assistance apparatus comprising:
a camera configured to capture an image around a vehicle; and
a processor configured:
to adjust a frame rate of the camera in order to cause motion blur in an image acquired through the camera;
to detect an object based on the image in which the motion blur occurs; and
to provide a control signal based on determination as to whether the detected object is located in a blind zone.

2. The driver assistance apparatus according to claim 1, wherein the processor is configured:
to receive information about a speed of the vehicle; and
to set the frame rate based on the speed information.

3. The driver assistance apparatus according to claim 2, wherein the processor is configured:
to perform control such that, the higher the speed of the vehicle, the higher the frame rate; and
to perform control such that, the lower the speed of the vehicle, the lower the frame rate.

4. The driver assistance apparatus according to claim 1, wherein the processor is configured:
to receive illumination information around the vehicle; and
to set the frame rate based on the illumination information.

5. The driver assistance apparatus according to claim 4, wherein the processor is configured to perform control such that, the lower a value of illumination around the vehicle, the lower the frame rate.

6. The driver assistance apparatus according to claim 1, wherein the processor is configured to generate information about a relative speed between the vehicle and the object based on an extent of the motion blur occurring on the detected object.

7. The driver assistance apparatus according to claim 6, wherein the processor is configured to set the frame rate based on the relative speed information.

8. The driver assistance apparatus according to claim 7, wherein the processor is configured to perform control such that, the higher relative speed, the higher the frame rate.

9. The driver assistance apparatus according to claim 1, wherein the processor is configured to classify another vehicle traveling in an adjacent lane from among a plurality of objects detected based on the image in which the motion blur occurs.

10. The driver assistance apparatus according to claim 1, further comprising:
a display, wherein
the processor is configured to perform cropping the detected object and to perform control such that an image of the cropped object is displayed on the display.

11. The driver assistance apparatus according to claim 10, wherein the processor is configured to set a direction in which the object image is displayed based on information about a direction in which the object approaches the vehicle.

12. The driver assistance apparatus according to claim 10, wherein the processor is configured to set a size of the object image based on information about a distance between the object and the vehicle.

13. The driver assistance apparatus according to claim 12, wherein the processor is configured to perform control such that, the smaller a value of the distance between the object and the vehicle, the larger the size of the object image.

14. The driver assistance apparatus according to claim 10, wherein the processor is configured to determine whether motion blur occurs in the cropped object image.

15. The driver assistance apparatus according to claim 14, wherein the processor is configured to adjust the frame rate upon determining that motion blur occurs in the cropped object image.

16. The driver assistance apparatus according to claim 15, wherein the processor is configured:
to acquire information about a relative speed between the vehicle and the object based on the motion blur occurring in the cropped object image; and
to adjust the frame rate based on the relative speed information.

17. The driver assistance apparatus according to claim 1, further comprising:
an interface, wherein
the processor is configured:
to receive steering input information through the interface; and
to apply a graphical effect to the object image based on the steering input information.

18. The driver assistance apparatus according to claim 17, wherein the processor is configured to perform control such that the object image is highlighted in a case in which steering is input in a direction approaching the object.

19. The driver assistance apparatus according to claim 1, further comprising:
an interface, wherein
the processor is configured to provide a control signal for controlling steering to a steering driver through the interface upon determining that the detected object is located in the blind zone.

20. A vehicle comprising:
the driver assistance apparatus according to claim 1; and
a plurality of wheels configured to be driven based on a control signal provided by the driver assistance apparatus.
